(19) United States
(12) Patent Application Publication
(10) Pub. No.: US 2018/0152404 A1
(43) Pub. Date: May 31, 2018

(54) EMAIL INTERACTION ANALYSIS AND PROPAGATION

(71) Applicant: International Business Machines Corporation, Armonk, NY (US)

(72) Inventors: Kirstin E. COPPEN, Eastleigh (GB); Jacqueline CLARKE, Southampton (GB); Martin A. ROSS, Gosport (GB); Stephanie J. STRUGNELL, Eastleigh (GB); Claudia WALTER, Winchester (GB)

(21) Appl. No.: 15/362,444

(22) Filed: Nov. 28, 2016

(51) Int. Cl. H04L 12/58; G06F 3/0485; G06F 3/0488

(52) U.S. Cl. CPC H04L 51/16; G06F 3/0488; G06F 3/0485

(57) ABSTRACT

A system, method and computer program product for managing electronic messages. Embodiments include receiving a conversation document associated with an electronic message. A plurality of sections within the conversation document are determined. Embodiments monitor user interactions with the plurality of sections of the conversation document and, for each of the plurality of sections of the conversation document, determine a measure of relative importance for the section based on user interactions observed by the monitoring. A graphical user interface depicting the electronic message is updated based on the determined measures of relative importance, and is output for display using one or more display devices.

### BACKGROUND

The present invention relates to electronic messaging, and more specifically, to the analysis and communication of electronic messages comprising conversations and conversation threads.

### SUMMARY

Embodiments provide a method, system and computer program product that include receiving a conversation document associated with an electronic message. The method, system and computer program product also include determining a plurality of sections within the conversation document. Additionally, the method, system and computer program product include monitoring user interactions with the plurality of sections of the conversation document. For each of the plurality of sections of the conversation document, the method, system and computer program product include determining a measure of relative importance for the section based on user interactions observed by the monitoring. The method, system and computer program product further include updating a graphical user interface depicting the electronic message, based on the determined measures of relative importance, and outputting the graphical user interface for display using one or more display devices.

### BRIEF DESCRIPTION OF THE SEVERAL VIEWS OF THE DRAWINGS

So that the manner in which the above-recited aspects are attained and can be understood in detail, a more particular description of embodiments of the present disclosure, briefly summarized above, may be had by reference to the appended drawings. Note, however, that the appended drawings illustrate only typical embodiments of this present disclosure and are therefore not considered limiting of its scope, for the present disclosure may admit to other equally effective embodiments.

FIG. 1 is a block diagram of a system comprising a computing device according to an example implementation of the present disclosure.

FIG. 2 is a flowchart illustrating a method for electronic message analysis according to an example implementation of the present disclosure.

FIG. 3 is a flowchart illustrating a method for data analysis, for use in the method of FIG. 2, according to an example implementation of the present disclosure.

FIG. 4 is a schematic block diagram illustrating a model, for determining a relative importance of sections of an electronic message, according to an example implementation of the present disclosure.

### DETAILED DESCRIPTION

The present disclosure relates to the analysis and communication of electronic messages comprising conversations and conversation threads between multiple users. In the following description, the messages comprise email messages that are sent and received by email client applications of user devices in accordance with standard email messaging techniques and protocols. As the skilled person will appreciate, the present disclosure is equally applicable to other forms of electronic messages, which may be sent and received by other types of client application, web interface or the like, for the communication of conversations and conversation threads by user devices.

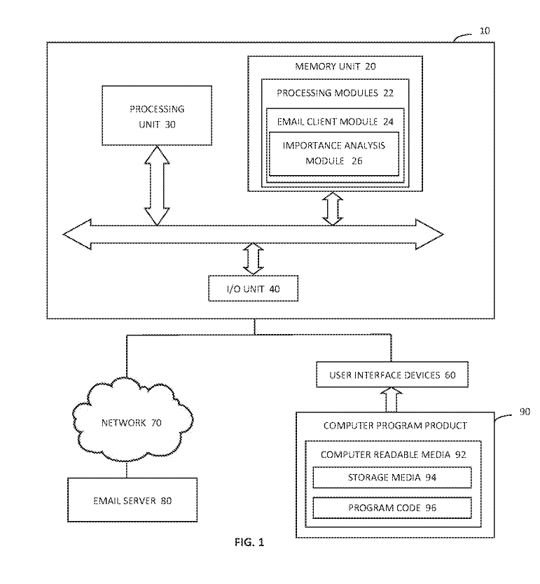

With reference now to FIG. 1, a block diagram of a system comprising a computing device 10 in accordance with example implementations of the present disclosure. Computing device 10 may comprise any type of user device for processing data including electronic messages, such as a personal computer or laptop, tablet device, personal digital assistant, cell phone or other mobile computing device. Computing device 10 comprises a memory unit 20 in communication with a processing unit 30. Memory unit 20 comprises memory for storing data for processing by processing unit 30, including processing modules 22 comprising program code for execution by processing unit 30. In addition, computing device comprises an input/output (I/O) unit 40 comprising a communication interface for enabling communication of data by computing device 10 to and from external devices connected thereto. Such external devices may include, for example, user interface devices 60 connected via peripheral connections such as USB or Bluetooth. Such external devices may include other user devices and server devices, including email server 80, connected via wired or wireless connection to one or more networks 70 such as a cellular communications network, a Local/Wide Area Network (LAN/WAN) or the Internet.

In accordance with example implementations of the present disclosure, memory unit 20 includes an email client module 24 configured for communicating electronic mail (i.e., email) messages with devices of other users over one or more networks 70. For example, email client module 24 may communicate email messages with computing devices of other users or an email server 80 via I/O unit 40 over the Internet in accordance with standard email messaging techniques and protocols. Email client module 24 may comprise any known or yet to be developed client or user email application for processing, communicating and displaying email messages. Examples of such email client or user applications include: IBM® Notes®, IBM® Verse, Evernote, Google Inc.'s Gmail™ and Microsoft® Outlook®.

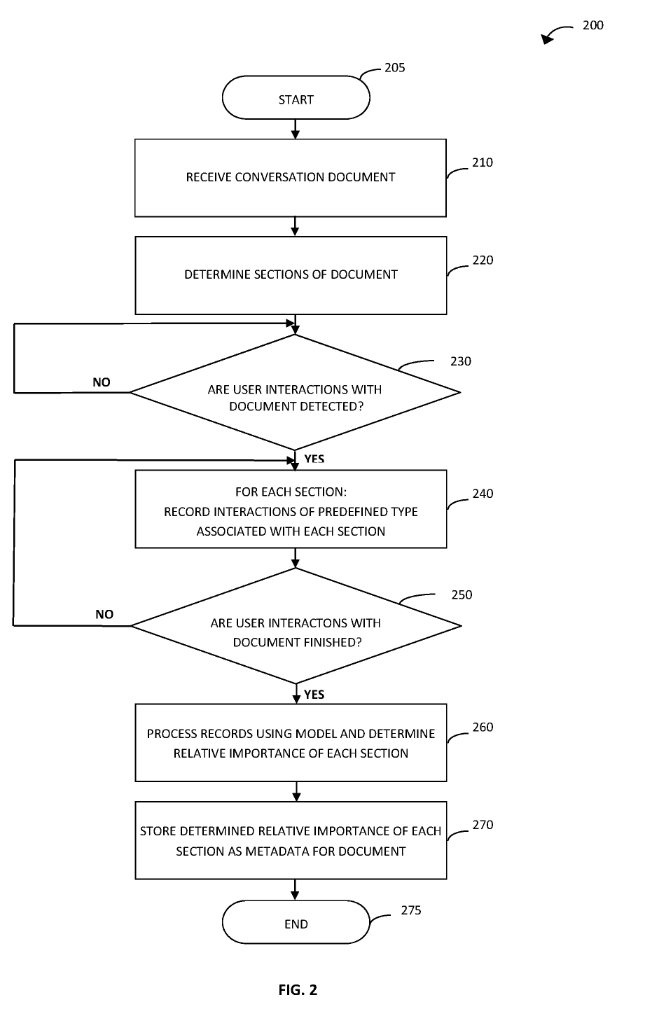

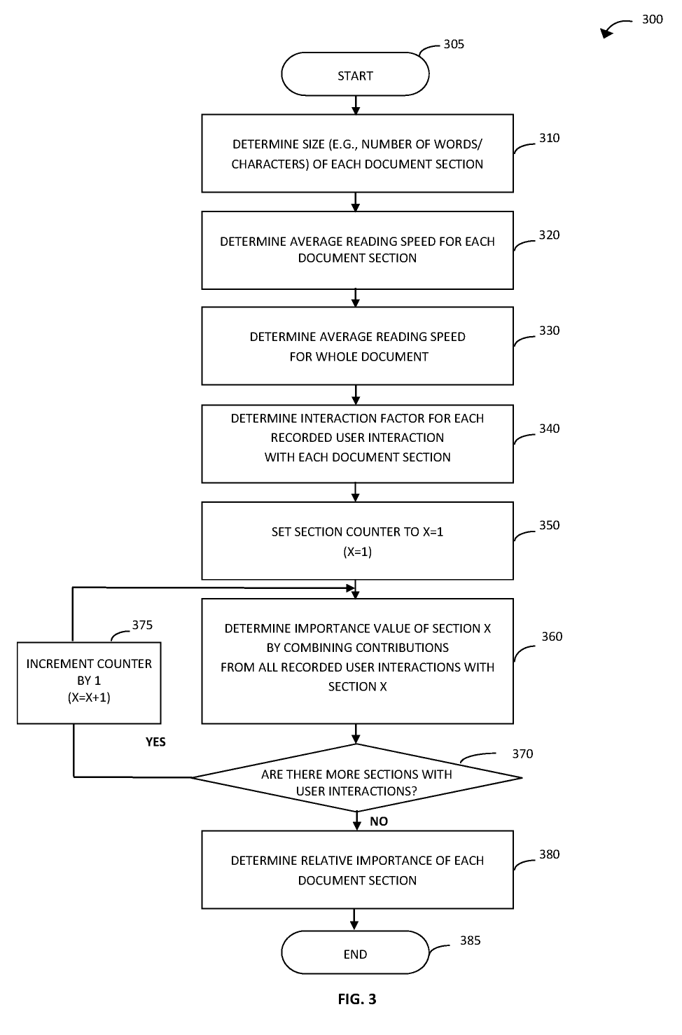

In addition, in accordance with example implementations of the present disclosure, email client module 24 includes an importance analysis module 26, for analyzing received electronic messages and determining the relative importance of sections of conversations or conversation threads therein. Example methods, which may be performed by importance analysis module 26, are described below with reference to FIGS. 2 and 3.

In accordance with example implementations of the present disclosure, importance analysis module 26 may monitor user interface devices 60, such as a mouse, touchpad keyboard, touchscreen, camera, etc., to detect and record data relating to user interactions with an email message. Importance analysis module 26 may analyze the recorded data to determine a level of importance or relative importance of sections of the email message. The importance analysis module 26 may generate metadata relating to the monitored user interactions, the determined level of importance or relative importance, for sections of the email message. Such metadata may be appended to, or encoded within, the email message, and may be sent to an email server and/or to other user devices with future communications of the email message.

In example implementations of the present disclosure, a computer program product 90 may be provided, as shown in FIG. 1. The computer program product 90 may include a computer readable media 92 having storage media 94 and program instructions 96 (i.e., program code) embodied therewith. The program instructions 96 may be loaded onto memory unit 20 of computing device 10, for example as the above-described importance analysis module 26 of email client module 24. The program instructions 96 may be executable by processing unit 30 to perform electronic message analysis and processing as described below with reference to FIGS. 2 and 3.

FIG. 2 is a flowchart illustrating a method 200 for electronic message analysis in accordance with example implementations of the present disclosure. In particular, although not exclusively, the method 200 may be performed by importance analysis module 26 of email client module 24 of the computing device 10 of FIG. 1.

The method 200 starts at block 205. The method may start in response to a user initiating a new interaction with an email message, for example by opening the email message for viewing in an email client application. As indicated above, in other example implementations, the method may relate to other forms of electronic message comprising a conversation or conversation thread. At block 210 the method receives a conversation document associated with the email message. Such a conversation document may comprise text, images and other features of the email message that may be displayed to the user by an email client application on a display of a user device. At block 220, the method identifies one or more sections of the conversation document. For example, the method may divide the conversation document into sections, such as “header”, “body” and “signature”. In addition, the body of the conversation document may be divided into sections according to the formatting of the corresponding text. For example, individual “paragraphs” or “bullet/numbered lists” of a text “body” may be treated as separate sections. Similarly, individual features such as “hyperlinks”, “graphics” (with or without surrounding text) and collapsible sections, included within the “body” may be treated as separate sections.

At block 230, the method monitors for user interactions with the displayed email message (i.e., conversation document) and determines whether user interactions are detected. Block 230 may monitor for one or more predefined types of user interaction with the conversation document via user interface devices. Examples of predefined types of user interactions include, without limitation, reading, hovering, performing touch screen gestures, selecting, clicking (e.g., single/double mouse-clicking or equivalent), copying and pasting, and the user manually marking or highlighting an important/interesting section. Reading interactions with a section of a document may be detected using an eye-tracking camera configured for capturing images of the eyes of a user viewing the corresponding section of the email message on a display screen. Suitable eye-tracking technology solutions that may be used are available from EyeTracking, Inc of San Diego, Calif., U.S.A. and Tobii A B of Danderyd, Sweden. In addition, reading interactions with a section of a document may be detected by identifying user interface device interactions with the section indicative of reading, such as scrolling. Non-reading interactions may be detected by monitoring user interface devices (e.g., mouse, touchpad or touchscreen) for operations indicative of user interactions, such as selecting, clicking, copying and pasting. If block 230 determines that user interactions with the conversation document are not detected, the method continues to monitor for user interactions at block 230. However, if block 230 determines that user interactions with the conversation document are detected, the method proceeds to block 240.

At block 240, the method records user interactions with each section of the conversation document. For example, an eye-tracking camera may be used to record a time period, during which the user is reading each section of the conversation document when displayed as an email message. User interactions such as clicking a hyperlink of a section of the conversation document, or copying and pasting a section of the conversation document, may be detected based on signals from user interface devices (e.g., mouse, touchpad or touchscreen) and recorded as corresponding user interactions at block 240.

At block 250, the method determines whether user interactions with the conversation document are finished. Block 250 may determine that user interactions with the conversation document are finished in response to a user terminating interaction with the email message, for example by closing the email message in the email client application, or by replying to, or forwarding, the email message from the email client application to one or more other users. If block 250 determines that user interactions with the conversation document are not finished, the method returns to block 230 and repeats block 240 if and when further user interactions with the conversation document are detected. However, if block 250 determines that user interactions with the conversation document are finished, the method proceeds to block 260.

At block 260, the method processes and analyzes the data recorded for the observed user interactions from monitoring in block 240, and determines an importance or relative importance of each section of the conversation document. Examples of the processing and analysis used to determine the importance or relative importance of each section of the conversation document in step block are described below with reference to FIG. 3. At block 270, the method stores values for the determined importance or relative importance of each section of the conversation document as metadata with the electronic message. As discussed above, in example implementations of the present disclosure, the metadata may be appended to, or encoded within, the email message. Thus, the metadata may be displayed when the email message is next opened by the user, or sent with the email message to other users for display when the email message is opened by those users, as described in more detail below. Furthermore, the metadata may be sent to an email server for further processing or distribution, for example as described below. The method then ends at block 275.

FIG. 3 is a flowchart illustrating a method 300 for electronic message analysis in accordance with example implementations of the present disclosure. In particular, although not exclusively, the method 300 may be performed by importance analysis module 26 of email client module 24 of the computing device 10 of FIG. 1. The method 300 may be used for the processing and analysis of data relating to recorded/observed user interactions with an email message, for example as in block 260 of the method 200 of FIG. 2.

The method starts at block 305. At block 310, the method determines the size of each section of the conversation document of the electronic message. In example implementations of the present disclosure, block 310 may determine the size of each section of the conversation document based on the number of words or characters in the text of the corresponding section. At block 320 the method determines the user's average reading speed for each individual section of the document. Block 320 may determine the user's average reading speed for a section based on a recorded time period of monitored user reading interactions with the section (e.g., as recorded in block 240 of the method of FIG. 2) and the size of the section (determined at block 310). For example, the size of the section (e.g., in words) may be divided by the recorded time period (e.g., in minutes) to calculate the user's average reading speed (e.g., in words per minute). Alternatively, the average reading speed may be calculated as the average time for reading a word (e.g., in seconds per word). Other, more complex, calculations may be performed to calculate the user's average reading speed, by taking into account factors such as natural pausing by the user at the beginning and end of reading of a section or the user reading the same section of the document multiple times (e.g., due to a user initially speed-reading a section followed by a more in-depth reading of the same section). As the skilled person will appreciate, any suitable technique may be used to determine the user's average reading speed, or an equivalent parameter associated with the user's reading interactions, to indicate the perceived level of importance or relative importance of sections of the electronic message to the user.

At block 330, the method determines the user's average reading speed for the conversation document. In particular, block 330 may determine the user's average reading speed for all of the sections of the document, with which the user has recorded reading interactions. Thus, the user's average reading speed for the conversation document may be based on the sum of the total recorded time of monitored reading interactions with the sections of the document (for example as recorded in block 240 of the method of FIG. 2) and the sum of the size of the corresponding sections (determined at block 310). The user's average reading speed for the conversation document may be determined using any of the abovementioned types of calculation used for determining the average reading speed for each individual section of the conversation document.

At block 340, the method determines an interaction factor, for each different recorded/observed user interaction, for each section of the conversation document. In example implementations of the present disclosure, an interaction factor for a reading interaction with a section of the conversation document may be determined based on the user's average reading speed for that section relative to the user's average reading speed for the conversation document. In example implementations of the present disclosure, an interaction factor for a non-reading user interaction, such as clicking on a hyperlink or copying/pasting, may be predetermined based on the type of non-reading user interaction. In example implementations of the present disclosure, an interaction factor for a user interaction may be based on the type of data associated with the corresponding (reading or non-reading) user interaction. The interaction factors determined in block 340 may be used as a weight for determining the perceived importance or relative importance of the sections of the electronic message to the user, as described in further detail below.

At block 350, the method selects a first section of the conversation document, by setting a section counter X=1. At block 360, the method determines an importance value for the selected (i.e., first) section based on all recorded/observed user interactions with the section. In example implementations of the present disclosure, a weighting factor is predefined for each type of user interaction based on the perceived importance of the user interaction type. Thus, for each recorded/observed user interaction with a selected section, a contribution to the importance of the section may be based on the predefined weighting factor for the interaction type combined with the interaction factor. In other example implementations of the present disclosure, a weighting factor is predefined for each type of data associated with the user interaction based on the perceived importance of the data type. Thus, for each observed user interaction with a selected section, a contribution to the importance of the section may be based on the predefined weighting factor for the data type combined with the interaction factor. Example methods for determining the importance value in block 360 are provided below.

At block 370, the method determines whether there are any further sections of the conversation document to be analyzed. For example, block 370 may determine whether there are any further sections having data for recorded/observed user interactions. If block 370 determines that there are additional sections of the conversation document to be analyzed, the method continues with block 380, in which the section counter is incremented by 1 (X=X+1) and returns to block 360 for determining the importance value for the next (i.e., second) section of the conversation document. However, if block 370 determines that there are no additional sections of the conversation document to be analyzed, the method proceeds to block 390.

At block 380, the method may determine the relative importance of each section of the conversation document. For example, block 380 may rank the sections of the document in order of their corresponding importance value, as determined in block 360. Alternatively, block 380 may assign a relative importance level (e.g., very important, fairly important, neither important/unimportant, fairly unimportant and very unimportant) or relative importance score (e.g., between 0 and 5, where 5 is very important) to each section of the document based on its corresponding importance value, as determined at block 360. As the skilled person will appreciate, any suitable technique for distinguishing between the importance of sections of the conversation document, so as to determine their relative importance, are possible and contemplated by the present disclosure. Examples of techniques for performing block 380 are provided below. The method then ends at block 385.

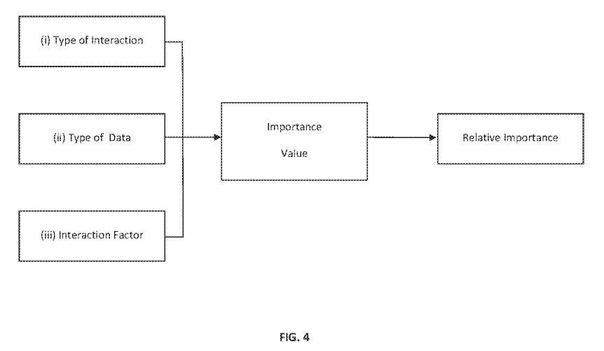

FIG. 4 is a schematic block diagram illustrating a model, for determining the relative importance of sections of a conversation document in accordance with example implementations of the present disclosure. In particular, the model may be used in the method of FIG. 3. Thus, an importance value for a section may be determined by combining the respective contributions to importance of each of the recorded/observed user interactions with the section, as described above in relation to block 360 of FIG. 3. In accordance with the illustrated model, for each user interaction instance, a contribution to importance is determined using three parameters: (i) the type of interaction, (ii) the type of data, and (iii) an interaction factor. Values for these parameters may be used as weights and weighting factors, as discussed above. In accordance with example implementations of the present disclosure, a parameter value/weighting factor for: the type of interaction (parameter (i)), and the type of data (parameter (ii)), is predefined according to a perceived relative significance to importance of the type of interaction and data, respectively. For example, a copying/pasting user interaction type may have a higher parameter value/weighting factor than a reading user interaction type, since copying/pasting suggests the user considers the data to be important. Similarly, a bullet list data type may have a higher parameter value/weighting factor than a plain text data type, since a bullet list is generally used by an author to summarize information or emphasize is a significant part of the text, which is likely to be important. In addition, in accordance with example implementations of the present disclosure, a parameter value/weight for: an interaction factor (parameter (iii)) may be based on the relative reading speed for a reading user interaction or a predetermined value/weight for other non-reading user interactions, as determined in block 340 of the method of FIG. 3 described above.

Returning to FIG. 4, for each user interaction with a section of a conversation document, a contribution to the importance value of the section is determined based on the values/weights of the above three parameters. In accordance with the model of FIG. 4, the contributions of all user interactions with the section are combined to determine an importance value of the section, as in block 360 of the method of FIG. 3. Once the importance values of all sections of the conversation document are determined, the model determines a relative importance of each section, as in block 380 of the method of FIG. 3.

The following example uses methods according to of FIGS. 2 and 3, and an example model according to FIG. 4, to determine a relative importance of sections of an email message comprising conversations and conversation threads forming a conversation document, with five sections as follows:
Section 1=Plain text (100 words)
Section 2=Plain text (80 words)
Section 3=Bullet list (50 words)
Section 4=Table (50 words)
Section 5=Plain text (110 words)

A user opens the email message using an email client application on a user device, and the email client application starts the method of FIG. 2 (block 205). The email client application receives the conversation document of the email message (block 210). The client email application divides the conversation document into five sections, Sections 1 through 5 (block 220). The client email application monitors user interactions with the email message displayed by the user device (block 230). The client email application records observed user interactions for each section (block 240) as user interaction instances as follows:
Section 1=10 seconds reading, clicked link embedded in text
Section 2=12 seconds reading, copied text
Section 3=10 seconds reading
Section 4=20 seconds reading
Section 5=8 seconds reading

The user closes the email message, and the email client application determines that user interactions have finished (block 250). The client email application starts the method of FIG. 3 (block 305). The email client application determines a word count for each section, as set out above (block 310). The email client application uses the records of the time of the observed reading interaction instances and the word count for each section to determine an average reading speed (RS) for each section, in seconds per word (block 320) as follows:
Average RS Section 1=0.1 seconds/word
Average RS Section 2=0.15 seconds/word
Average RS Section 3=0.2 seconds/word
Average RS Section 4=0.4 seconds/word
Average RS Section 5=0.07 seconds/word

The email client application determines and uses the total word count for the conversation document and the total reading time for Sections 1 through 5 to determine an average reading speed (RS) for the conversation document, in seconds per word (block 330) as follows:
Average RS Conversation document (Sections 1 through 5)=0.15 seconds/word

In the example model, the weight/value of interaction factor (parameter (iii)) for all non-reading user interaction instances is predefined as follows:
Non-Reading Interaction Factor=1

The weight/value of the interaction factor (parameter (iii)) for reading user interaction instances for a section X comprises the relative average reading speed:

Reading Interaction Factor=Average RS Section X/Average RS Conversation Document Eqn. 1

Using equation 1, the email client application determines the weights/values for the interaction factor (parameter (iii)) for the observed reading interaction instances for each section (block 340) as follows:
Reading Interaction Factor Section 1=0.66
Reading Interaction Factor Section 2=1.00
Reading Interaction Factor Section 3=1.33
Reading Interaction Factor Section 4=2.67
Reading Interaction Factor Section 5=0.47

In the example model, the following weights/values are predefined for: the type of user interaction (parameter (i)), and the type of data (parameter (ii)) as shown in Table 1.

TABLE 1

| Type of Interaction (i) | Type of Data (ii) | Parameter value ((i) or ii)) |
|---|---|---|
| Reading | — | 4 |
| Clicking Link | — | 5 |
| Copying/Pasting | — | 10 |
| Manual Marking | — | 10 |
| — | Plain text | 3 |
| — | Bullet list | 7 |
| — | Table | 7 |

The email client application inputs the recorded/observed user interaction instances for each section into the model of FIG. 4 to determine the corresponding parameter values (i) through (iii) as shown in Table 2:

TABLE 2

| | Type of Interaction | Type of Data | Interaction Factor |
|---|---|---|---|
| Section | (Parameter (i)) | (Parameter (ii)) | (Parameter (iii)) |
| Section 1 | Reading - 4 | Plain text - 3 | 0.66 |
| Section 1 | Click on link - 5 | Link within plain | 1 |
| | | text - 3 | |
| Section 2 | Reading - 4 | Plain text - 3 | 1 |
| Section 2 | Copy/Paste - 10 | Plain text - 3 | 1 |
| Section 3 | Reading - 4 | Bullet List - 7 | 1.33 |
| Section 4 | Reading - 4 | Table - 7 | 2.67 |
| Section 5 | Reading - 4 | Plain text - 3 | 0.47 |

A contribution to importance of each observed user interaction instance is determined as follows:

Contribution (User Interaction)=(type of interaction (i))*(type of data (ii))*(interaction factor (iii)) Eqn. 2

The email client application determines the importance value for each section as the sum of the contributions (determined using equation 2) of all observed user interaction instances associated with that section (block 360) as follows:
Section 1—Importance Value=(4*3*0.66)+(5*3*1)=22.92
Section 2—Importance Value=(4*3*1)+(10*3*1)=42
Section 3—Importance Value=(4*7*1.33)=37.24
Section 4—Importance Value=(4*7*2.67)=74.76
Section 5—Importance Value=(4*3*0.47)=5.64

The importance values for each section of a conversation are processed by the email client application to determine the relative importance of each section (block 380). The processing may be based on a simple ranking so that Section 4 has the highest ranking (highest importance value=74.76) and Section 5 has the lowest ranking (lowest importance value=5.64). Alternatively, the processing may be based on percentile ranking of importance values. Percentile ranking, which is based on a frequency distribution of data points, is well known in the art. For example, sections with an importance value >=75th percentile are deemed highest level of importance, sections with an importance value in the 50th-75th quartile are the next level of importance etc. In the example, the 75th percentile is at 42, so sections 2 and 4 are the most important, the 50th percentile is at 37.24, so section 3 is in the 2nd level of importance and so on. The use of percentile ranking may be particularly beneficial in the case of larger conversation documents with large numbers of sections from the same or different conversation threads.

As the skilled person will appreciate, various statistical techniques may be used to optimize the analysis to determine a level of importance or relative importance of sections of a conversation document. For instance, example implementations may choose to assign an interaction factor of 0 to user interactions deemed to indicate no relative importance (i.e., user interactions that do not signify greater or lesser importance). In addition, margins of error may be applied. Thus, in example implementations, relative average reading speeds within a margin of error of the average reading speed of the conversation document may be deemed to have the same reading interaction factor (e.g., an interaction factor=1). For example, consider average reading speeds for a document having three sections: Section 1=10 ms/word, Section 2=12 ms/word, Section 3=11 ms/word. As all of these values are within the margin of error of 20% of the average reading speed for the document, none would be deemed important over the others. Thus, all of the user reading interaction instances may be assigned the same weight/value for the interaction factor (parameter (iii)). In contrast, if the average reading speeds were: Section 1=10 ms/word, Section 2=20 ms/word, Section 3=11 ms/word, then the reading speed for Section 2 is above of the average reading speed for the document by more than the margin of error of 20%, and so would be deemed more important. Thus, the user reading interaction instance for Section 2 may be assigned a higher weight/value for the interaction factor (parameter (iii)).

As the skilled person will appreciate, in the example implementations described above with reference to FIGS. 2, 3 and 4, an email client application determines a relative importance of sections of a conversation document of an email message for an individual user. As an email message is viewed and exchanged by multiple users running a client application according to the present disclosure, data for the relative importance of the sections of the document for the multiple users may propagated and aggregated to determine a more reliable indication of the relative importance of the email sections. Thus, if an email message having existing relative importance metadata (based on observed user interactions of one or more other users) is received by an email client application, the email client application may additionally use the existing metadata, for example in block 380 of the method of FIG. 3, to determine an aggregate importance or relative importance of the sections of the document. Any suitable aggregation technique may be used for such aggregation of importance or relative importance of sections of a document using existing metadata and new metadata.

As the skilled person will appreciate, in the example implementations described above with reference to FIGS. 2, 3 and 4, the email client application records user interaction instances associated with sections of an email message, derives metadata from the data and stores the user interactions instances and metadata locally in a database. When the email client application sends the email message to a further recipient, the interaction data and/or metadata may be retrieved from the local database and appended to, or encoded within, the email message. Thus, the further recipient may consume important information contained in the email message more efficiently and effectively. In example implementations of the present disclosure, the metadata may be included in the header of the outgoing email message, so that the further recipient is able to simply review metadata in the header to identify which sections of data have been interacted with and/or are considered more (or less) important. In other example implementations, the email message sent to the further recipient may be augmented with tags and/or special characters within the body of the email message to identify specific sections deemed to be important based on the derived metadata. For example, the email body may include tags against sections that are identified as important in the header. The email client application of the recipient would then be able to identify these tags by scanning the content of the email body and remove the tags themselves (leaving the content being tagged) or utilize them for highlighting etc. Alternatively, the metadata in the header may reference offsets/paragraphs directly, without any tags within the email body content.

In other example implementations of the present disclosure, an email client application may send the interaction data and metadata to a central email server rather than propagate the data through a reply/forward email chain. In this way, information may be available to all participants in the email chain substantially in real time, rather than making the information available only to subsequent recipients. Thus, a central email server may store the interaction data and metadata associated with an email chain at a central location. The central server may make the interaction data and/or metadata available to users of the email chain, for example by means of updates at periodic time intervals (e.g., hourly, daily etc.) or in response to participant user actions (e.g., a participant sending a reply), or in response to requests from client applications triggered at periodic time intervals or triggered by participant user actions (e.g., a participant opening the email) , using standard techniques.

In example implementations of the present disclosure, an email client application may provide a notification to a sender of an email message indicating the metadata to be included in the email header (or elsewhere), for example as a prompt prior to sending. The notification may allow the user to confirm that the metadata should be sent or discard sections of the metadata before sending.

As the skilled person will appreciate, metadata derived in accordance with the present disclosure may be used to provide new graphical user interfaces (GUIs) and associated features, for users to navigate email chains and similar electronic messages. In one example implementation, a GUI may provide a view highlighting the sections of an email message that are relatively important (e.g., by “greying out” or “collapsing” relatively unimportant sections or highlighting relatively important sections in bold). In another example implementation, a GUI may provide a “Jump to next/previous interesting point” button, for enabling a user to navigate through only the interesting points (i.e., relatively important sections) in the conversation document of the email message. Such GUIs may allow the user to more quickly identify conversation threads of a conversation document of most significance, thus saving time.

In example implementations of the present disclosure, an email client application of a user device having limited network access, network bandwidth or other resources may only download sections of an email message having a defined minimum level of importance or relative importance. For example, the email client application may provide the user with a feature to make a selection indicating a minimum level of importance or relative importance of email message sections to be received, in order to save on bandwidth utilization, volume of data downloads etc.

The metadata derived in accordance with the present disclosure may be used to improve written communications, particularly in a business context. For example, a user may be able to determine from the metadata that a manager, customer or other business associate typically only reads the first paragraph of emails sent by the user. The user may utilize this information to improve subsequent communications with that person, for example by providing an executive summary in the first paragraph when writing future emails. Similarly, a sender may register to receive a report on their email compositions based on metadata associated with recipient user interactions, in order to obtain information to assist in improving their email writing in the future.

In the above detailed description, the “importance value” (or “importance”) of a section of a conversation document is determined from observed parameters of user interactions with the section using a predefined formula. The “relative importance” of a section is determined by categorizing the determined importance value of the section. As the skilled person will appreciate, the determined importance value of a section is itself indicative of the relative importance of the section and so may be used as the relative importance in metadata, as described above, without further processing such as categorization or ranking. Accordingly, the term “relative importance” of a section of a conversation document should be understood as including both output values of a method for determining importance based on observed user interaction parameters and outputs of categorization, ranking or the like.

Whilst the described example uses a model, having input parameters (i) to (iii) in accordance with FIG. 4, for the processing and analysis of user interaction data, other models with more or fewer input parameters are possible and contemplated. In addition, any suitable technique for the analysis of user interactions may be used or developed, for example using machine learning, to optimize the resulting metadata.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., IBM® Notes®, IBM® Verse, Evernote, Google Inc.'s Gmail™ and Microsoft® Outlook®) or related data available in the cloud. For example, the IBM® Notes® could execute on a computing system in the cloud, receive a conversation document associated with an electronic message, monitor user interactions with a plurality of section of the conversation document, and determine a relative importance of each of the plurality of sections of the conversation document based on user interactions observed by the monitoring. In such a case, the email application could monitor ongoing user interactions to identify whether a notable event has occurred during the course of viewing any given email and store the user interaction instances and metadata at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
receiving a conversation document associated with an electronic message;
determining a plurality of sections within the conversation document;
monitoring user interactions with the plurality of sections of the conversation document;
for each of the plurality of sections of the conversation document, determining a measure of relative importance for the section based on user interactions observed by the monitoring;
updating a graphical user interface depicting the electronic message, based on the determined measures of relative importance; and
outputting the graphical user interface for display using one or more display devices.

2. The method of claim 1, further comprising:
dividing the conversation document into the plurality of sections.

3. The method of claim 1, further comprising:
for each of the plurality of sections of the conversation document:
determining a contribution to importance for each observed user interaction with the section; and
combining the contributions to determine an importance value for the section.

4. The method of claim 3, wherein the contribution to importance of an observed user interaction is determined based on one or more of:
a type of user interaction;
a type of data associated with the user interaction; and
an interaction factor associated with the user interaction.

5. The method of claim 1, wherein the monitoring comprises:
monitoring one or more predefined types of user interaction with the conversation document when the electronic message is displayed on a display screen of an electronic device,
wherein the predefined types of user interaction include one or more of: reading, scrolling, pointing, hovering, performing touch-screen gestures, selecting, copying, and pasting of text within the electronic document.

6. The method of claim 1, wherein a relative importance of a section of the conversation document is determined based on a reading speed of observed user reading interactions with the section of the conversation document relative to a reading speed of observed user reading interactions with one or more of the other sections of the document.

7. The method of claim 1, further comprising determining that sections of the conversation document with a slower relative reading speed are more important than other sections of the conversation document.

8. The method of claim 1, further comprising:
determining an importance value for each section of the conversation document, based on observed user interactions therewith;
comparing the importance value of each section with the importance value of one or more of the other sections of the plurality of sections; and
determining a relative importance of each sections based on the comparison.

9. The method of claim 8, wherein determining the relative importance of a section comprises one of: ranking the sections based on importance value, and determining a relative level of importance based on the importance value.

10. A system, comprising:
one or more computer processors; and
a memory containing computer program code that, when executed by operation of the one or more computer processors, performs an operation comprising:
receiving a conversation document associated with an electronic message;
determining a plurality of sections within the conversation document;
monitoring user interactions with the plurality of sections of the conversation document;
for each of the plurality of sections of the conversation document, determining a measure of relative importance for the section based on user interactions observed by the monitoring;
updating a graphical user interface depicting the electronic message, based on the determined measures of relative importance; and
outputting the graphical user interface for display using one or more display devices.

11. The system of claim 10, the operation further comprising:
storing data relating to the observed user interactions within the memory.

12. The system of claim 10, the operation further comprising:
dividing the conversation document into the plurality of sections.

13. The system of claim 10, the operation further comprising:
for each of the plurality of sections of the conversation document:
determining a contribution to importance for each observed user interaction with the section; and
combining the contributions to determine an importance value for the section.

14. The system of claim 13, wherein the contribution to importance of an observed user interaction is determined based on one or more of:
a type of user interaction;
a type of data associated with the user interaction; and
an interaction factor associated with the user interaction.

15. The system of claim 10, wherein monitoring user interactions with the plurality of sections of the conversation document further comprises:
monitoring one or more predefined types of user interaction with the conversation document when the electronic message is displayed using the one or more display devices,
wherein the predefined types of user interaction include one or more of: reading, scrolling, pointing, hovering, performing touch-screen gestures, selecting, copying, and pasting of text within the electronic document.

16. The system of claim 10, wherein a relative importance of a section of the conversation document is determined based on a reading speed of observed user reading interactions with the section of the document relative to a reading speed of observed user reading interactions with one or more of the other sections of the document.

17. The system of claim 10, the operation further comprising: determining that sections of the conversation document with a slower relative reading speed are more important than other sections of the conversation document.

18. The system of claim 10, the operation further comprising:
determining an importance value for each section of the conversation document, based on observed user interactions therewith;
comparing the importance value of each section with the importance value of one or more of the other sections of the plurality of sections; and
determining a relative importance of each sections based on the comparison.

19. The system of claim 10, the operation further comprising determining the relative importance of a section by one of: ranking the sections based on importance value, and determining a relative level of importance based on the importance value.

20. A computer program product, comprising:
a computer-readable storage medium containing computer-readable program code that, when executed by one or more computer processors, performs an operation comprising:
receiving a conversation document associated with an electronic message;
determining a plurality of sections within the conversation document;
monitoring user interactions with the plurality of sections of the conversation document;
for each of the plurality of sections of the conversation document, determining a measure of relative importance for the section based on user interactions observed by the monitoring;
updating a graphical user interface depicting the electronic message, based on the determined measures of relative importance; and
outputting the graphical user interface for display using one or more display devices.
